(19) United States
(12) Patent Application Publication
(10) Pub. No.: US 2006/0159802 A1
(43) Pub. Date: Jul. 20, 2006

(54) Limit dextrin-based syrups and confectionery products including same

(76) Inventors: David G. Barkalow, Deerfield, IL (US); Robert B. Friedman, Chicago, IL (US)

Correspondence Address: BELL, BOYD & LLOYD LLC, P. O. BOX 1135, CHICAGO, IL, 60690-1135, US

(21) Appl. No.: 11/303,219

(22) Filed: Dec. 15, 2005

Related U.S. Application Data
(60) Provisional application No. 60/639,871, filed on Dec. 22, 2004.

(51) Int. Cl. A23G 4/00; A23L 1/236

(52) U.S. Cl. 426/3; 426/548

(57) ABSTRACT

Syrups for use in confectionery products, including chewing gum, methods of making the syrup, confectionery products using the syrups and methods for making such confectionery products are presented. In an embodiment, the syrups comprise hydrogenated β-limit dextrin and maltitol.

### PRIORITY CLAIM

This application claims the benefit of U.S. Provisional Patent Application Ser. No. 60/639,871 filed on Dec. 22, 2004, the entire disclosure of which is hereby incorporated.

### BACKGROUND

The present invention relates generally to confectionery products. More specifically, the present invention relates to polyol-based syrups that can function in confectionery products including, for example, chewing gum compositions and confections and methods of preparation of the confectionery products and syrups.

There are numerous types of confectionery products for consumers. One such confectionery product is chewing gum. Chewing gum generally consists of a water insoluble portion and a water soluble portion including sweeteners.

In general, confectionery products such as chewing gum that are sold through commercial distribution channels should have an acceptable shelf-life. When formulated properly, the confectionery product should have a desired level of body and structure to provide adequate shelf life, long lasting crunch shelf life and stick or pellet center stability. However, during commercial distribution and storage, the confectionery product may either pick up or lose moisture and change body structure, depending on the confectionery composition and the relative temperature and humidity of the surrounding environment. For example, although expensive packaging may be used to prevent or retard water migration to or from the confectionery product, once the package is opened, the confectionery may quickly begin to pick up or lose moisture or lose body structure stability. Therefore, it would be desirable to produce a confectionery product which has greater stability with respect to moisture and structural properties.

In addition, confectionery products and chewing gum, often in pellet form, are frequently enclosed with a hard or soft coating. Coatings provide an opportunity for the manufacturer to vary product characteristics such as taste, appearance, structure and nutritional value. Coatings can be made from a variety of sugar and sugarless syrups. One problem with coated confectionery products that results from using conventional syrup compositions is the tendency of the coating to chip or crack, which can unfavorably modify the taste and appearance of the coated confectionery product.

Confectionery products may also include a flavor. Flavors are typically made from non-aqueous mixtures. One difficulty arises when the coating syrups are applied in a hot liquid state. For example, syrups are applied as a coating in a hot liquid state so that they can more rapidly dry. As a result, volatile flavors, such as fruit flavors, cannot be mixed into the coating syrup because the volatile components of the flavor will evaporate during the coating operation. Even if the flavors are pre-blended with the syrup just prior to being applied to the cores, there is still undesirable flavor loss.

A need, therefore, exists for improved syrups that can be used in chewing gums and other confections.

### SUMMARY

The present invention provides for confectionery products utilizing polyol-based syrups containing hydrogenated β-limit dextrins, methods of preparing such confectionery products and syrups, and the syrups themselves.

To this end, in an embodiment, the present invention provides for a syrup composition comprising one or more hydrogenated high molecular weight dextrins and a low molecular weight polyol, wherein the polyol is exclusively maltitol.

In an embodiment, the hydrogenated β-limit dextrin and maltitol are generated through hydrogenation of a β-limit dextrin syrup containing a β-limit dextrin and maltose made from waxy maize starch.

In an embodiment, the maltitol can comprise from about 25% to 75% by weight of the total syrup composition and the hydrogenated β-limit dextrin comprises from about 25% to 75% by weight of the total syrup composition.

In an embodiment, the syrup composition can further comprise a polyol selected from the group consisting of xylitol, sorbitol, erythritol, mannitol, isomalt, lactitol and combinations thereof.

In an alternative embodiment, the present invention provides a method of preparing a syrup composition, the method comprising hydrogenating a composition comprising β-limit dextrin and maltose

In a further embodiment, the present invention provides for a confectionery product comprising a syrup composition having hydrogenated β-limit dextrin and maltitol.

In an alternative embodiment, the present invention provides a chewing gum product comprising a chewing gum center and a coating surrounding the chewing gum center, wherein the coating includes a syrup composition having hydrogenated β-limit dextrin and maltitol.

In a further embodiment, the present invention provides a method of manufacturing a confectionery product comprising the steps of providing a confectionery center and coating the confectionery center in a coating step with at least one layer of a syrup composition having hydrogenated β-limit dextrin and maltitol. For example, the confectionery product can be a coated chewing gum and the confectionery center can be a chewing gum center.

In a further embodiment, the present invention provides a method of manufacturing a chewing gum composition comprising the steps of: providing a syrup composition including at least a hydrogenated β-limit dextrin syrup; providing a chewable gum base and at least one ingredient selected from the group consisting of bulk sweeteners, high intensity sweeteners, flavoring agents, softeners, emulsifiers, colors, acidulants, fillers, antioxidants, preservatives and combinations thereof; and combining the gum base in an amount from about 5% to about 90%, preferably 15-50%, by weight of the chewing gum composition, the ingredient in an amount from about 5% to about 90%, preferably 20-60%, by weight of the chewing gum composition, and the syrup in an amount from about 5% to about 90%, preferably 5-50%, by weight of the chewing gum composition to form a finished chewing gum composition.

In various embodiments, the present invention provides for compositions that are produced by various methods.

It is therefore an advantage of the present invention to provide a polyol-based syrup that can function in confectionery products including chewing gum.

Another advantage of the present invention is to provide improved coated confectionery products including chewing gum.

Yet another advantage of the present invention is to provide a plasticizer and humectant for use in stick and tab gum to give longer lasting shelf life and stability.

Still another advantage of the present invention is to provide a plasticizer and humectant for use in gum center to give a longer shelf life of gum, a longer lasting crunch shelf life and stick center stability.

Another advantage of the present invention is to provide a syrup that will confer stability to polyol coatings thereby reducing corner chipping and reducing pellet cracking of coated confectionery products.

Yet another advantage of the present invention is to provide an economical syrup that can be generated directly by hydrogenation of a β-limit dextrin syrup made from starch.

Still another advantage of the present invention is to provide a high molecular weight, yet water-soluble, dextrin that can serve as a carrier for flavors and high intensity sweeteners, whereby the carrier provides extended and controlled release of the ingredients such as flavors and/or sweeteners.

Additional features and advantages of the present invention are described in, and will be apparent from, the following Detailed Description.

### DETAILED DESCRIPTION

The present invention provides polyol-based syrups. More specifically, the present invention relates to syrups that contain very high molecular weight, water soluble, hydrogenated dextrins and low molecular weight polyols, particularly maltitol. Further, the present invention relates to polyol-based syrups that can be used to produce confectionery products along with methods of preparing such confectionery products and syrups. Although in the preferred embodiments set forth below the confectionery product is chewing gum, the present invention is not limited to chewing gum. For example, the present invention can be used in other confectionery products, including soft and hard candies.

In general, β-amylase enzyme activity is used, in conjunction with conventional amylases, to generate high maltose syrups. Use of β-amylase enzymes alone are known to act on starch to produce low molecular weight species, typically maltose, and high molecular weight species, known as β-limit dextrins. With certain exceptions, most starches found in nature are composed of a mixture of amylopectin and amylose. Amylose is a linear molecule which is almost completely hydrolyzed by β-amylase enzymes into maltose and glucose. Amylopectin, a branched molecule, is hydrolyzed into maltose and higher molecular weight dextrins because the β-amylase enzyme is unable to hydrolyze past the α-1-6 branch point in the amylopectin molecule.

If the enzymatic hydrolysis of amylopectin is allowed to proceed to its fullest extent, the remainder of the amylopectin molecule will form what is known as β-limit dextrin. The action of pure β-amylase enzyme activity has been reported in the production of β-limit dextrins from certain starches, for example, such as waxy maize starch and dull waxy maize.

Waxy maize starch is known to be comprised of about 100% amylopectin. The low molecule weight product of a pure β-amylase enzyme activity on amylopectin is exclusively maltose. As discussed previously, however, the enzyme stops within a few glucose units of the branch resulting in a high molecular weight water-soluble dextrin, the β-limit dextrin, thereby forming a β-limit dextrin and maltose syrup. Hydrogenation of this syrup can yield a syrup having a bimodal mixture of hydrogenated β-limit dextrin and maltitol or an HBLD syrup.

Because the dextrin products can be separated from the maltose produced by the enzyme, another benefit from the water-soluble high molecular weight dextrin syrup can be obtained. For example, a membrane process may be used to separate the high quality maltose.

To prepare a high maltose syrup containing a β-limit dextrin and maltose, nothing needs to be done other than removing any buffers or protein discoloration. The syrup can then be hydrogenated directly to yield a high maltitol and hydrogenated β-limit dextrin (HBLD) syrup. Thus, an economical syrup can be generated directly by hydrogenation of a β-limit dextrin syrup made from waxy maize starch. This can provide cost savings when using such syrups in polyol-based coatings of manufactured confectionery products of the present invention.

Furthermore, the non-hydrogenated syrup β-limit dextrin and maltose could serve effectively in sugar gums through the presence of a high maltose syrup. This can replace gum arabic binder in confectionery coatings.

In one embodiment of the invention, the syrup composition comprises hydrogenated β-limit dextrin and maltitol (“HBLD syrup”). Preferably, the maltitol component comprises from about 25% to 75% by weight of the total syrup composition. Preferably, the hydrogenated β-limit dextrin component comprises from about 25% to 75% by weight of the total syrup composition. It should be appreciated that numerous other constituents can be added to the syrup composition depending on its use.

In another embodiment, the HBLD syrup can be used to make confectionery products, and more specifically, chewing gum. For example, the HBLD syrup could be put into the chewing gum center as a sweetener or softener. Sweeteners and mixed HBLD syrup in chewing gum would be released over time as the gum is chewed. As a softener, for example, the HBLD syrup composition could be used to substitute for glycerin.

In an alternative embodiment, the present invention provides a method of manufacturing a confectionery product comprising the steps of providing a confectionery center and coating the confectionery center in a coating step with at least one layer of a syrup composition having hydrogenated β-limit dextrin and maltitol. It should be appreciated that numerous other constituents can be added to the syrup composition used for any coating layer. This syrup may be used to confer stability to polyol coatings by reducing corner chipping and pellet cracking in coated confectionery products.

In another embodiment of the invention, a method of manufacturing a coated chewing gum comprises the steps of providing a chewing gum center and coating the chewing gum center in a coating step with at least one layer of a syrup composition having hydrogenated β-limit dextrin and maltitol.

In another embodiment, the present invention provides a method of manufacturing a chewing gum composition comprising the steps of: providing a syrup composition including at least hydrogenated β-limit dextrin and maltitol; providing a chewable gum base and one or more ingredients selected from the group consisting of bulk sweeteners, high intensity sweeteners, flavoring agents, softeners, emulsifiers, colors, acidulants, fillers, antioxidants, preservatives and combinations thereof; and combining the gum base in an amount from about 5% to about 90%, preferably 15-50%, by weight of the chewing gum composition, the ingredients in an amount from about 5% to about 90%, preferably 20-60%, by weight of the chewing gum composition, and the syrup in an amount from about 5% to about 90%, preferably 5-50%, by weight of the chewing gum composition to form a finished chewing gum composition. In an embodiment of the invention, the polyol-based syrup of the present invention can be used as a plasticizer and humectant in gum center formulas to provide a longer shelf life of gum, a longer lasting crunch shelf life and pellet center stability.

In one embodiment of the invention, the substrate starch used to produce maltitol and hydrogenated β-limit dextrin is one that is all amylopectin, such as waxy maize starch. It should be appreciated that any suitable common starch can also be used including, but not limited to, corn, rice, wheat, tapioca, maize, potato, barley, oat, and, more generally, any starch suitable for enzymatic hydrolysis catalyzed by β-amylase may be used in connection with the invention. In an alternative embodiment, the starch can have any suitable amylose content and may be a partially derivatized or otherwise modified starch, or may be a starch that has been thinned or enzymatically treated. For example, a starch that has been lightly oxidized may also be employed.

The polyol in the HBLD syrup in the present invention is maltitol. However, other polyols can be added to the HBLD syrup with the present invention. For example, other such suitable polyols include, but are not limited to, xylitol, sorbitol, erythritol, mannitol, isomalt, lactitol and combinations thereof.

In general, a chewing gum composition typically comprises a water-soluble bulk portion, a water-insoluble chewable gum base portion and typically water-insoluble flavoring agents. The water-soluble portion dissipates with a portion of the flavoring agent over a period of time during chewing. The gum base portion is retained in the mouth throughout the chew.

The HBLD syrups of the present invention may include non-polyol ingredients which are commonly used in sugar and sugarless coatings. However, polyol coatings are preferred for sugarless coatings. The specific ingredients and their usage levels will vary greatly according to the intentions for the formulation. The use of one or more fillers (e.g., titanium dioxide, talc, calcium carbonate, silicon dioxide) in the present invention may be advantageous. In this regard, these inorganic materials aid the coating process by giving the HBLD syrup coatings a smoother finish. Furthermore, these inorganic fillers enhanced the ease with which polyols could be used, and in many instances substantially increased the crunchiness of the product.

It may be desirable to provide chewing gum products that have different coating layers comprising various polyol coatings. In this regard, such coating types can be applied using methods known in the art, such as spraying the coating materials onto the gum pellets. Spraying can be alternately started and stopped to allow layers of coating to dry onto the surface of the pieces. Forced air and dry powder additionally may be used to speed the drying process. The various parameters of the operation (spray time, dry time, air temperature, tumbling speed and others) will vary greatly from one system to another and may well vary within a coating batch and from batch to batch. They will be set based on the skill and experience of the developer and operator. Typical coating equipment usable in the present invention will include any suitable apparatus normally used for this purpose, with the exception of the spray nozzles, which must be atomizing nozzles to spray the molten polyol. Simple systems may comprise conventional motor-driven coating pans with manually controlled spray nozzles and drying air. However, more sophisticated automated systems such as Driam and Dumoulin Coaters are preferred.

In addition to the coatings of the present invention applied by spraying, optionally flavors may be separately sprayed onto the pieces during the coating process to provide a flavored coating. If used, this flavor may constitute from about 0.01 to 3% of the total coating with levels of 0.5 to 2% being preferred.

Optionally a final polishing coat may be applied to the pieces after the polyol coatings have been applied. The polishing coat may use a wax, such as carnauba wax, or shellac. It may also include fillers such as talc and colors. The polishing coat is typically 0.1 to 0.5% of the total coating.

As noted above, the present invention can be used to create coated chewing gum. A variety of chewing gum formulations can be used to create the chewing gum center. Chewing gum generally consists of a water insoluble gum base, a water soluble portion, and flavors.

The insoluble gum base generally comprises elastomers, resins, fats and oils, softeners, and inorganic fillers. The gum base may or may not include wax. The insoluble gum base can constitute approximately 5 to about 95 percent, by weight, of the chewing gum, more commonly, the gum base comprises 10 to about 50 percent of the gum, and in some preferred embodiments, 20 to about 35 percent, by weight, of the chewing gum.

In an embodiment, the chewing gum of the present invention contains about 20 to about 60 weight percent synthetic elastomer, 0 to about 30 weight percent natural elastomer, about 5 to about 55 weight percent elastomer plasticizer, about 4 to about 35 weight percent filler, about 5 to about 35 weight percent softener, and optional minor amounts (about one percent or less) of miscellaneous ingredients such as colorants, antioxidants, etc.

Synthetic elastomers may include, but are not limited to, polyisobutylene with a GPC weight average molecular weight of about 10,000 to about 95,000, isobutylene-isoprene copolymer having styrene-butadiene ratios of about 1:3 to about 3:1, polyvinyl acetate having a GPC weight average molecular weight of about 2,000 to about 90,000, polyisoprene, polyethylene, vinyl acetate-vinyl laurate copolymer having vinyl laurate content of about 5 to about 50 percent by weight of the copolymer, and combinations thereof.

Preferred ranges are, for polyisobutylene, 50,000 to 80,000 GPC weight average molecular weight, for styrene-butadiene, for polyvinyl acetate, 10,000 to 65,000 GPC weight average molecular weight with the higher molecular weight polyvinyl acetates typically used in bubble gum base, and for vinyl acetate-vinyl laurate, vinyl laurate content of 10-45 percent.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters, often called estergums, such as glycerol esters of partially hydrogenated rosin, glycerol esters polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing the preferred elastomer plasticizers will also vary depending on the specific application, and on the type of elastomer which is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes additional ingredients such as a bulking agent or water soluble bulk portion and one or more flavoring agents. For example, the ingredients can include bulk sweeteners, high intensity sweeteners, flavoring agents, softeners, emulsifiers, colors, acidulants, fillers, antioxidants, preservatives and other components or processing aids or combinations thereof that provide desired attributes.

Softeners can be added to the chewing gum in order to optimize the chewability and mouth feel of the gum. The softeners, which are also known as plasticizers and plasticizing agents, generally constitute between approximately 0.5 to about 15% by weight of the chewing gum. The softeners may, in addition to including caprenin, include glycerin, lecithin, and combinations thereof. Aqueous sweetener solutions such as those containing sorbitol, hydrogenated starch hydrolysates, corn syrup, other polyols or sugars, such as tagatose, and combinations thereof, may also be used as softeners and binding agents in chewing gum.

Bulk sweeteners include both sugar and sugarless components. Bulk sweeteners typically constitute 5 to about 95% by weight of the chewing gum, more typically, 20 to 80% by weight, and more commonly, 30 to 60% by weight of the gum.

Sugar sweeteners generally include saccharide-containing components commonly known in the chewing gum art, including, but not limited to, sucrose, dextrose, maltose, dextrin, dried invert sugar, fructose, tagatose, galactose, corn syrup solids, and the like, alone or in combination.

Maltitol can be used as a sugarless sweetener. Additionally, sugarless sweeteners can include, but are not limited to, other sugar alcohols such as mannitol, xylitol, hydrogenated starch hydrolysates, sorbitol, lactitol, and the like, alone or in combination.

High intensity artificial or natural sweeteners can also be used in combination with the above. Preferred sweeteners include, but are not limited to sucralose, aspartame, salts of acesulfame, alitame, saccharin and its salts, cyclamic acid and its salts, glycyrrhizin, stevioside, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extrusion may be used to achieve the desired release characteristics.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8%. When carriers used for encapsulation are included, the usage level of the encapsulated sweetener will be proportionately higher.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Example of low caloric bulking agents include: polydextrose; Raftilose; Raftilin; Fructooligosaccharides (NutraFlora); Palatinose oligosaccharide; Guar Gum Hydrolysate (Sun Fiber); or indigestible dextrin (Fibersol). However, other low calorie bulking agents can be used.

A variety of flavoring agents can be used. The flavor can be used in amounts of approximately 0.1 to about 15 weight percent of the gum, and preferably, about 0.2 to about 5%. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion.

A variety of processes for manufacturing chewing gum center are possible as is known in the art.

Chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, extruding into chunks, or casting into pellets.

Generally, the ingredients are mixed by first melting the gum base and adding it to the running mixer. The gum base may alternatively be melted in the mixer. Color and emulsifiers can be added at this time, along with syrup and a portion of the bulking agent. Further portions of the bulking agent may then be added to the mixer. A flavoring agent is typically added with the final portion of the bulking agent. The entire mixing procedure typically takes from five to fifteen minutes, but longer mixing times may sometimes be required. Those skilled in the art will recognize that many variations of the above described procedures may be followed.

Once formed, the chewing gum center can be coated. In conventional panning, the coating is initially present as a liquid syrup which contains from about 30% to about 80% or 85% of the coating ingredients previously described herein, and from about 15% or 20% to about 70% of a solvent such as water. In general, the coating process is carried out in conventional panning equipment. Sugarless gum center tablets to be coated are placed into the panning equipment to form a moving mass.

In the conventional panning process, the material or syrup which will eventually form the coating is applied or distributed over the gum center tablets. Flavors may be added before, during and after applying the syrup to the gum centers. Once the coating has dried to form a hard surface, additional syrup additions can be made to produce a plurality of coatings or multiple layers of coating.

In the conventional panning procedure, syrup is added to the gum center tablets at a temperature of from about 100° F. to about 240° F. Preferably, the syrup temperature is from about 140° F. to about 200° F. Most preferably, the syrup temperature should be kept constant throughout the process in order to prevent the polyol in the syrup from crystallizing. The syrup may be mixed with, sprayed upon, poured over, or added to the gum center tablets in any way known to those skilled in the art.

In some instances, a soft coating is formed by adding a powder coating after a liquid coating. The powder coating may include natural carbohydrate gum hydrolysates, maltodextrin, gelatin, cellulose derivatives, starches, modified starches, sugars, sugar alcohols, natural carbohydrate gums and fillers like talc and calcium carbonate.

Each component of the coating on the gum center may be applied in a single layer or in a plurality of layers. In general, a plurality of layers is obtained by applying single coats, allowing the layers to dry, and then repeating the process. The amount of solids added by each coating step depends chiefly on the concentration of the coating syrup. Any number of coats may be applied to the gum center tablet. Preferably, no more than about 75 coats are applied to the gum center. More preferably, less than about 60 coats are applied and most preferably, about 30 to 60 coats are applied. In any event, the present invention contemplates applying an amount of syrup sufficient to yield a coated chewing gum product containing about 10% to about 65% coating. Preferably, the final product will contain at least 30% coating.

Those skilled in the art will recognize that in order to obtain a plurality of coated layers, a plurality of premeasured aliquots of coating syrup may be applied to the gum center. It is contemplated, however, that the volume of aliquots of syrup applied to the gum center may vary throughout the coating procedure.

In the conventional coating process, once a coating of syrup is applied to the gum center, drying is done on the wet syrup in an inert medium. A preferred drying medium comprises air. Preferably, forced drying air contacts the wet syrup coating in a temperature range of from about 70° F. to about 110° F. More preferably, the drying air is in the temperature range of from about 80° F. to about 100° F. The invention also contemplates that the drying air possess a relative humidity of less than about 15 percent. Preferably, the relative humidity of the drying air used between syrup applications is less than about 8 percent.

The drying air may be passed over and admixed with the syrup coated gum centers in any way commonly known in the art. Preferably, the drying air is blown over and around the syrup coated gum centers at a flow rate, for large scale operations, of about 2800 cubic feet per minute. If lower quantities of material are being processed, or if smaller equipment is used, lower flow rates would be used. If a flavor is applied after a syrup coating has been dried, the present invention contemplates drying the flavor with or without the use of a drying medium.

### EXAMPLES

By way of example and not limitation, the following examples are illustrative of various embodiments of the present invention.

### Example 1

### (Syrup)

This example illustrates the preparation of β-limit dextrin from waxy maize corn starch. Starch from waxy corn can be made to an aqueous slurry containing 12 to 15% solids and pH 6.0 to 7.0. The slurry can then be liquefied by jet cooking through a Hydro Thermal Jet (Model #M103-030) at 300° F., 60 to 65 psi with a 5 minute residence time at 300° F., 50 to 55 psi. The liquefact can be immediately cooled, the pH adjusted to 5.5 with hydrochloric acid, and dosed with β-amylase. Using a commercial barley β-amylase enzyme (Genencor OPTIMALT BBA), dosing can be made with 6.15 DP units per kilogram of starch or 0.05 wt. % grams of liquid enzyme per gram of dry starch. Saccharification can be performed at 140° F. for 4 to 24 hours. After saccharification, the β-amylase can be inactivated by adjusting the pH to 2.7. After inactivation, the hydrolyzate can then be adjusted to a pH of 4.8 and carbon filtered giving a β-limit dextrin syrup. This β-limit dextrin syrup containing β-limit dextrin and maltose can then be hydrogenated to give HBLD and maltitol. After another filtration, the syrup can then be concentrated to a 75% solids syrup by evaporation.

### Example 2

Examples of chewing gum demonstrate formulations with the HBLD syrup containing hydrogenated β-limit dextrin and maltitol are as follows:

| | A | B |
|---|---|---|
| Sorbitol | 48.60% | 49.60% |
| Base | 25.00% | 25.00% |
| Glycerin | 11.40% | 4.40% |
| 75% HBLD syrup | 12.67% | 19.67% |
| Spearmint Flavor | 1.09% | 0.78% |
| Coolants | 0.46% | 0.76% |
| Lecithin | 0.30% | 0.30% |
| Encapsulated Sweeteners | 0.34% | 0.34% |
| Salt Solution * | 0.10% | 0.10% |
| Color | 0.04% | 0.04% |
| Total | 100% | 100% |

* Contains 10% NaCl and 90% water

### Example 3

The following is an example of using HBLD syrup in a gum center and gum coating:

| | Gum Center |
|---|---|
| Sorbitol | 39.5% |
| Base | 32.0% |
| Calcium Carbonate | 15.0% |
| 75% HBLD syrup | 7.5% |
| Encapsulated Menthol | 2.2% |
| Menthol | 0.9% |
| Eucalyptus flavor | 0.8% |
| Glycerin | 0.9% |
| Encapsulated sweeteners | 0.9% |
| Coolant | 0.3% |
| Total | 100.0% |

### Example 4

This gum center formulation can be used to make coated formulas with the following formulations:

Coating

| | C | D |
|---|---|---|
| Maltitol | 91.5% | 80.3% |
| Gum Arabic | 1.5% | 1.5% |
| HBLD syrup | 4.0% | 14.0% |
| Titanium Dioxide | 1.0% | 1.0% |
| Eucalyptus flavor | 0.8% | 1.1% |
| Menthol and Coolant | 0.4% | 1.0% |
| Intense Sweetener | 0.5% | 0.8% |
| Color | 0.1% | 0.1% |
| Polishing Agents | 0.2% | 0.2% |
| Total | 100% | 100% |

The gum center of Example 3 can be coated as in Coating C to give a 33% coated product containing 4% HBLD syrup. Using the gum center of Example 3, the formula for coating in Coating D can give a 33% coated product containing 14% HBLD syrup in the coating.

### Example 5

A eucalyptus/menthol hard candy can be made with good cooling using the following process and formulation:

| | Hard Candy |
|---|---|
| Isomalt | 67.68% |
| HBLD syrup | 31.00% |
| Acesulfame K | 0.05% |
| Aspartame | 0.10% |
| Flavor | 0.80% |
| Coolants | 0.35% |
| Color | 0.02% |
| Total | 100.0% |

Isomalt, HBLD syrup, and acesulfame K can be mixed in water and cooked until the cooked syrup reaches a moisture level of about 1-3% forming a thick syrup. The thick syrup can be poured on a stainless steel cooling table and allowed to cool. Aspartame, eucalyptus flavor, color, and the coolants can then be added and mixed by kneading. The mix is cooled to room temperature and cut as needed.

### Example 6

A mint flavored chewing candy can be made with the HBLD syrup using the following formula and process:

| | Weight, g |
|---|---|
| Gelatin mixture, A | |
| Gelatin | 21.0 |
| Water | 27.5 |
| Syrup mixture, B | |
| Water | 42.5 |
| HBLD syrup | 256.5 |
| Isomalt | 121.0 |
| Fat component, C | |
| AC Humko SP97 fat | 30.0 |
| ADM Panallite monoglyceride | 0.5 |
| Lecithin | 1.0 |
| Components, D | |
| Isomalt | 44.0 |
| Mint flavor blend | 2.5 |
| Intense Sweeteners | 0.8 |
| Color | 0.2 |

Process:
1. Combine ingredients in A and allow to hydrate and mix in a Hobart
mixing bowl.
2. Combine ingredients in B in a pan, cook to 285 F., and add to Hobart
mixing bowl and mix with A.
3. Mix A and B in Hobart at low speed until mixture thickens, then whip
for 2-5 minutes.
4. Melt C.
5. Combine D and melted C and add slowly to Hobart with low speed
mixing.
6. Cool and form into chunks.

### Example 7

After the chewy candy is formed in pieces as in Example 6, the chewy candy can also be pan coated with an HBLD syrup according to the following formulation to give a coated chewy candy:

| Ingredient | Weight, g |
|---|---|
| Maltitol | 500 |
| Water | 175 |
| HBLD syrup | 50 |
| Sweetener | 1 |
| Titanium Dioxide | 3 |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A syrup composition comprising hydrogenated β-limit dextrin and maltitol.

2. The syrup composition of claim 1, wherein the hydrogenated β-limit dextrin and maltitol are generated by the hydrogenation of a β-limit dextrin syrup made from waxy maize starch.

3. The syrup composition of claim 1, wherein the maltitol comprises from about 25% to 75% by weight of the total syrup composition and the hydrogenated β-limit dextrin comprises from about 25% to 75% by weight of the total syrup composition.

4. The syrup composition of claim 1, further comprising a polyol selected from the group consisting of xylitol, sorbitol, erythritol, mannitol, isomalt, lactitol and combinations thereof.

5. A method of preparing a syrup composition, the method comprising:
hydrogenating a composition comprising β-limit dextrin and maltose

6. A confectionery product comprising a syrup composition having hydrogenated β-limit dextrin and maltitol.

7. A chewing gum product comprising a chewing gum center and a coating surrounding the chewing gum center, wherein the coating includes a syrup composition having hydrogenated β-limit dextrin and maltitol.

8. The chewing gum product of claim 7, wherein the chewing gum center comprises a gum base and at least one ingredient selected from the group consisting of bulk sweeteners, high intensity sweeteners, flavoring agents, softeners, emulsifiers, colors, acidulants, fillers, antioxidants, preservatives and combinations thereof.

9. A method of manufacturing a confectionery product, the method comprising:
providing a confectionery center; and
coating the confectionery center in a coating step with at least one layer of a syrup composition comprising hydrogenated β-limit dextrin and maltitol.

10. The method of claim 9, wherein the confectionery product is a coated chewing gum and the confectionery center is a chewing gum center.

11. A method of manufacturing a chewing gum composition, the method comprising:
providing a syrup composition including hydrogenated β-limit dextrin and maltitol;
providing a chewable gum base and at least one ingredient selected from the group consisting of bulk sweeteners, high intensity sweeteners, flavoring agents, softeners, emulsifiers, colors, acidulants, fillers, antioxidants, preservatives and combinations thereof; and
combining the gum base in an amount from about 5% to about 90% by weight of the chewing gum composition, the ingredient in an amount from about 5% to about 90% by weight of the chewing gum composition, and the syrup composition in an amount from about 5% to about 90% by weight of the chewing gum composition to form a finished chewing gum composition.
